(19) United States
(12) Patent Application Publication
(10) Pub. No.: US 2026/0341567 A1
(43) Pub. Date: Oct. 29, 2026

(54) APPARATUS HAVING A MAGNETORHEOLOGICAL TRANSMISSION DEVICE

(71) Applicant: INVENTUS Engineering GmbH, St. Anton i.M. (AT)

(72) Inventors: Johannes Haag, Schruns (AT); Stefan Battlogg, St. Anton i.M. (AT)

(21) Appl. No.: 19/106,297

(22) PCT Filed: Jul. 5, 2023
(86) PCT No.: PCT/EP2023/068597

§ 371 Date: Feb. 25, 2025

(30) Foreign Application Priority Data
Aug. 25, 2022 (DE) 10 2022 121 536.9

(51) Int. Cl. H01F 7/08; H01F 1/44; H01F 27/28

(52) U.S. Cl. CPC H01F 7/081; H01F 1/447; H01F 27/28

(57) ABSTRACT

An apparatus with a magnetorheological transmission device having two rotating components that can be moved in relation to each other. A gap is formed between the two rotating components, in which gap a magnetorheological medium is located. An electrical coil device is used to generate a controlled magnetic field inside the gap in order to influence the rotation of the rotating components during normal operation. A malfunction protection device serves to brake the rotation of the rotating components in the event of failure. The malfunction protection device is configured to generate a magnetic field by means of a magnetic field generation device and to influence the magnetorheological medium present in the gap by means of the magnetic field in order to brake the rotation of the rotating components via an emergency brake torque.

The invention relates to a device with at least one magnetorheological transmission device with at least two rotary components that can be moved relative to one another. At least one effective gap is formed between the rotating components, in which a magnetorheological medium is arranged. By means of at least one electrical coil device, a controllable magnetic field can be generated in the effective gap in order to influence the rotatability of the rotating components during normal operation.

Such devices can, for example, be designed as an operating device and serve to set operating states. Then, for example, different moments or forces, stops and grids for the movements can be set using the magnetorheological transmission device. This means that haptic (perceptible) feedback can be transmitted during operation, which supports the user and allows very targeted settings and overall reduces the operating complexity. Such operating devices are being used more and more frequently in a wide variety of devices, for example in motor vehicles or medical technology or even in smart devices, for example to select menus or carry out precise controls. In addition, such devices are increasingly being used to operate computers and game consoles. The device should therefore be designed to be very compact and at the same time reliable and have the lowest possible basic torque.

For example, such devices can also be used as a steering specification device for specifying a steering movement according to the steer-by-wire concept. High demands are placed on such steering control devices. So, for example, precise steering feedback and backlash-free or jerk-free steering behavior, especially around the center position, as well as very smooth, harmonious steering behavior are required. If the steering unit is generally designed to be (mechanically) difficult to move (=high basic torque), it is no longer possible to have a tactilely perfect control in normal operation (active reset . . . ). Only very smooth-running steering units (preferably <0.1 Nm basic torque of all steer-by-wire steering components) enable haptically sophisticated and harmonious steering movements. In addition, the steering device must provide high torque or be able to counteract the manual steering movement (the torque then corresponds to a braking torque). This is, for example, to represent end stops, for support when getting out or as a counter torque during very fast twisting or steering movements.

A crucial feature of such devices is safety in the event of a malfunction and, for example, in the event of a failure of the coil device (so-called failsafe case). Then there is no longer any torque opposing the rotational movement or steering movement and no resistance is felt during operation. In order to defuse such sometimes very dangerous situations, an accident protection system can be used to brake the rotation of the rotating components in the event of an accident. However, the structural integration of accident prevention often leads to an increase in installation space and weight as well as an increase in the basic torque.

It is therefore the object of the present invention to provide a device with improved accident protection which particularly advantageously meets the previously discussed requirements.

This object is achieved by a device with the features of claim 1. Preferred developments of the invention are the subject of the subclaims. Further advantages and features of the present invention result from the general description and from the description of the exemplary embodiments.

The device according to the invention comprises at least one magnetorheological transmission device. The transmission device comprises at least two rotary components that can be moved relative to one another. At least one effective gap is formed between the rotating components. At least one magnetorheological medium is arranged in the effective gap. The device comprises at least one electrical coil device for generating a controllable magnetic field in the effective gap. In particular, the generation of the magnetic field serves to influence (and preferably brake or release) the rotatability of the rotating components during normal operation. The device comprises at least one malfunction protection device for braking the rotation of the rotary components in the event of an accident. The accident prevention system is suitable and designed to generate a magnetic field by means of at least one magnetic field generating device and to use the magnetic field to influence the magnetorheological medium arranged in the effective gap. In particular, the rotatability of the rotating components is braked with an emergency braking torque.

The device according to the invention offers many advantages. Malfunction protection with its magnetic field generation device offers a significant advantage. Such magnetorheological accident protection can be designed to be much more compact and lighter than, for example, mechanical accident protection. A further advantage is that the magnetic field generating device acts on the magnetorheological medium arranged in the effective gap. Such a constructive integration of the accident prevention into the magnetorheological transmission device requires few components and installation space.

It is preferred and advantageous that the magnetic field of the coil device and the magnetic field of the magnetic field generating device acts on the same effective gap and preferably also on the same magnetorheological medium. In particular, a common effective gap is provided for the transmission device and the accident prevention system. In particular, the effective gap formed between the rotating components also provides the effective gap for accident prevention.

In particular, the effective gap is formed circumferentially around one of the rotating components. The effective gap can have at least one or at least two or more gap sections. The magnetic field of the magnetic field generating device can act on the same gap section and/or on a different (adjacent) gap section of the effective gap. In particular, the gap sections are connected to one another and in particular fluidly connected.

In particular, the magnetic field of the coil device and the magnetic field of the magnetic field generating device run through the rotation components and the effective gap (and in particular through the magnetorheological medium received in the effective gap).

Preferably, the magnetic field of the coil device and the magnetic field of the magnetic field generating device run through a common magnetic circuit. This means that in the event of a fault, the magnetic field of the coil device can be compensated by the magnetic field of the magnetic field generating device. This is very helpful, for example, if the coil device is accidentally subjected to maximum current. This would not be possible (easily) with separate magnetic circuits.

It is also possible and preferred that the magnetic field of the coil device and the magnetic field of the magnetic field generating device each run through at least one magnetic circuit and that these magnetic circuits overlap at least in sections. In particular, the rotational components each represent at least one section of the Magnetic circuit ready. In particular, the magnetic circuits overlap at least in one of the rotational components and preferably in both rotational components.

Within the magnetic circuit, the field lines run parallel to one another at least in sections. In particular, the magnetic circuit has a homogeneous distribution of the field lines (especially in comparison to the field lines in air). In particular, the magnetic fields flow through a closed magnetic circuit.

In a particularly advantageous development, the magnetic field generating device comprises at least one additional electrical coil device for generating the magnetic field. In particular, the accident device is suitable and designed to control the additional coil device depending on an operating state of the coil device.

In particular, the additional coil device is designed to be smaller and/or with a lower power than the coil device. In particular, the emergency braking torque is smaller and preferably at least twice smaller than a (operationally intended) maximum transmission torque or braking torque of the transmission device.

In particular, the additional coil device and the coil device each comprise at least one separate supply line for supplying (electrical) energy. In particular, the supply lines emerge from one of the rotating components at different locations and preferably at different axial end faces.

The accident protection preferably comprises at least one (electrical) energy storage device for supplying energy to the additional coil device. In particular, the energy storage provides an energy supply, which is from an energy supply the coil device is independent. The energy storage in particular includes at least one rechargeable battery and/or at least one battery and/or at least one capacitor or the like. It is also possible for the additional coil device and the coil device to be supplied with energy via a common source. Then, in particular, separate supply lines are provided.

In an advantageous embodiment, at least one of the rotating components comprises at least one coil holder. In particular, at least the coil device is accommodated in the coil holder. The additional coil device is preferably also accommodated in the coil holder.

The coil holder is designed in particular as an (integral) component of one of the rotating components. The coil holder in particular comprises at least one receiving space and in particular at least one wall arrangement that at least partially surrounds the receiving space. In particular, the coil holder (preferably at least the wall arrangement) is designed to be at least partially magnetically conductive.

The magnetically conductive area of the coil holder can be equipped with a contour that projects into the effective gap. The contour can result in a gap height that varies in the circumferential direction. The contour can be designed, for example, as a star contour or the like.

In an advantageous development, the coil holder comprises a common receiving space for the coil device and the additional coil device. In particular, the coil device and the additional coil device are surrounded by a common wall arrangement.

It is also possible and advantageous for the coil holder to have at least one receiving space for the coil device and has at least one receiving space for the additional coil device. In embodiments without an additional coil device, in particular only the receiving space is provided for the coil device. The receiving spaces are in particular at least partially spatially separated. In particular, at least one partition wall is arranged between them, which is preferably designed to be magnetically conductive. The partition is provided in particular by the rotating component. In particular, the receiving spaces are arranged axially next to one another.

In a preferred development, the coil device and the additional coil device are accommodated in a common winding arrangement. Preferably, the coil device and the additional coil device are wound axially next to each other in the winding arrangement. In particular, the coil device and the additional coil device lie axially next to one another in the common receiving space. This enables particularly compact radial dimensions.

It is also possible and preferred that the coil device and the additional coil device are wound coaxially to one another in the winding arrangement. The additional coil device and the coil device are arranged at least partially aligned with respect to the radial direction. For example, the additional coil device can be located radially on the inside, while the coil device is arranged radially on the outside and surrounds the additional coil device in the circumferential direction. A reverse arrangement is also possible, in which the coil device is arranged radially on the inside and the additional coil device is arranged radially on the outside. This enables particularly compact axial dimensions.

It is possible that the coil device and the additional coil device are magnetically shielded (insulated) from each other. The coil device and the additional coil device can be separated from each other by a magnetically non-conductive layer, for example, made of plastic or a magnetically non-conductive casting compound.

In a further advantageous embodiment it is provided that the coil device and the additional coil device are wound into one another in the winding arrangement. In other words, the coil device and the additional coil device cannot be separated from each other without unwinding.

In particular, the winding arrangement comprises at least one electrical conductor for the coil device and at least one electrical conductor for the additional coil device.

The conductors are in particular electrically insulated from one another. In particular, the conductors each have a separate power supply. According to the winding arrangements described above, the different conductors can be wound axially next to one another or coaxially to one another or wound into one another. In the winding arrangement wound into one another, sections of one conductor then lie between sections of the other conductor. The conductors are, so to speak, mixed.

It is possible and advantageous for the magnetic field generating device to comprise at least one permanent magnet device for providing the magnetic field. In particular, the accident protection is suitable and designed to weaken or eliminate the magnetic field of the permanent magnet device in normal operation by means of the coil device and/or by means of the additional coil device. In particular, a magnetic field is generated by the coil device and/or the additional coil device, which specifically counteracts the magnetic field of the permanent magnet device. Such a permanent magnet device has the advantage that if the power supply to the coil device fails, the magnetic field for the emergency braking torque is automatically available. Sensor means or circuits for detecting the fault may be dispensed with if necessary.

It can be provided that the coil device generates a magnetic field during normal operation, which serves to specifically influence the rotatability of the rotating components and at the same time weakens the magnetic field of the permanent magnet device. Then the additional coil device can be dispensed with.

However, it is also possible and preferred that the weakening of the magnetic field of the permanent magnet device is carried out by the additional coil device during normal operation. The additional coil device can be provided exclusively for the counteracting magnetic field in normal operation. However, it is also possible for the additional coil device to act in addition to the permanent magnet device in the event of a fault and, for example, to support its magnetic field. As described in more detail below, the magnetic field of the permanent magnet device and/or the additional coil device can also be provided to support the magnetic field of the additional coil device during normal operation.

Two additional coil devices can also be provided so that one is available for attenuation in normal operation and the other for the emergency braking torque.

It is possible for the permanent magnet device to be provided by a component with magnetic remanence properties (so-called remanence device). Due to the remanence properties, the component retains its respective magnetic state permanently or at least until it is demagnetized or magnetized again. If necessary, such a component can be magnetized or demagnetized by the coil device and/or the additional coil device. The component is, for example, one of the rotating components or a section of one. The permanent magnet device is in particular designed in a ring shape. In particular, the permanent magnet device comprises at least one permanent magnet. For example, a ring magnet is provided. In particular, the permanent magnet device is arranged coaxially to the axis of rotation of the transmission device. The permanent magnet device can be axially polarized (or axially magnetized) or radially polarized (or radially magnetized).

In particular, the permanent magnet device is arranged axially next to the coil device and/or the additional coil device. The permanent magnet device can be arranged at least partially aligned with the coil device and/or the additional coil device with respect to the axial direction. However, an offset arrangement with respect to the axial direction is also possible.

In particular, the permanent magnet device is enclosed in the radial direction by the coil device and/or the additional coil device. It is also possible for the permanent magnet device to enclose the coil device and/or the additional coil device in the radial direction. In other words, the permanent magnet device is arranged at least partially aligned with the coil device and/or the additional coil device with respect to the radial direction. However, an offset arrangement with respect to the radial direction is also possible.

In all versions, these components are preferably arranged coaxially to one another and also coaxially to the axis of rotation of the transmission device. Preferably, the permanent magnet device is at least partially enclosed (in the radial direction) by at least one of the receiving spaces.

In an advantageous development, at least one magnetic flux barrier is assigned to the permanent magnet device. In particular, the flux barrier is suitable and designed to prevent a magnetic short circuit between the permanent magnet device and the rotary component carrying the permanent magnet device. In particular, the flux barrier extends in a disk shape around the axis of rotation of the transmission device. In particular, the flux barrier extends in a disk shape through the rotary component.

In particular, the permanent magnet device and the flux barrier are arranged coaxially to one another (and preferably coaxially to the axis of rotation of the transmission device). In particular, the permanent magnet device is at least partially enclosed by the flow barrier in the radial direction or at least partially encloses it in the radial direction. The flux barrier is formed in particular in the rotary component which carries the permanent magnet device and/or which carries the (additional) coil device provided for generating the counteracting magnetic field.

The flux barrier is preferably designed as an air gap or at least includes one. Another suitable magnetically non-conductive material is also possible. The flux barrier or the air gap is preferably at least so large that the magnetic resistance is greater than or equal to the magnetic resistance of the (effective) gap. Otherwise, it could happen that the magnetic field lines are closed across the flux barrier.

It is possible and advantageous that the flux barrier is provided by the permanent magnet device. In particular, the permanent magnet device extends to a radially inner and/or radially outer end of the rotary component. This also reliably prevents a magnetic short circuit.

It is preferred and advantageous that the fault protection is suitable and designed to reduce the magnetic field of the coil device by means of the additional coil device (in a controlled manner). In particular, this counteracts an undesirably large braking effect in the event of a fault.

The applicant reserves the right to claim a device according to the preamble of claim 1, which is equipped with such a fault protection. The magnetic fields of the coil device and the additional coil device preferably run in a common magnetic circuit.

In an advantageous development, at least one control device is provided, which is suitable and designed to use the magnetic field of the magnetic field generating device in normal operation to support the magnetic field of the coil device. This can be the magnetic field of the permanent magnet device and/or the additional coil device. Such support can be provided, for example, by activating the additional coil device during normal operation. Additionally, or alternatively, such support can also be provided by not weakening the magnetic field of the permanent magnet device during normal operation or by selectively weakening it to a lesser extent.

In the context of the present invention, an accident is understood to mean, in particular, a failure of the coil device. In particular, this results in the magnetic field of the coil device being eliminated. The accident protection serves in particular to ensure that the rotating components are neither blocked nor can be moved without resistance in the event of an accident. Without the accident protection presented here, the rotating components would be able to rotate freely in the event of an accident (apart from the basic torque). It is possible that the failure of the coil device is intentional (e.g. when the device is switched off). Then the accident prevention system preferably provides a parking brake, which secures the rotating components against unwanted movement.

In particular, the accident protection is suitable and designed to at least partially replace and/or support the magnetic field of the coil device by the magnetic field of the magnetic field generating device. In particular, the magnetic field generating device can provide a magnetic field if the magnetic field of the coil device disappears in the event of a fault. In particular, the magnetic field generating device can provide a magnetic field which supports the magnetic field of the coil device during normal operation and/or weakens it in the event of a fault.

In particular, the malfunction device is suitable and designed to detect the malfunction and in particular the failure of the coil device (e.g. with a sensor means). In particular, the accident prevention system is suitable and designed to automatically brake the rotatability of the rotating components with the accident braking torque when the accident is detected. A circuit can be provided which automatically activates the additional coil device in the event of a failure of the power supply to the coil device in order to brake with the emergency braking torque.

In particular, the transmission device can be used to specifically change the transmission of force or torque. In particular, the transmission of force or torque between the rotating components can be adjusted using the coil device and its magnetic field in the effective gap. In particular, this also results in a change in the resistance to movement for the rotation of the rotating components. The transmission device can be used as a clutch device or as a braking device. The rotating components then serve in particular as clutch components or as braking components and can be referred to as such. The torque can also be referred to as braking torque or clutch torque.

The device can be designed as an operating device for setting operating states by means of rotary movements and/or linear movements (which are converted into rotary movements). In particular, the movement resistance of the rotary movement can be specifically adjusted. Such an operating device is, for example, a rotary knob or a joystick or the like. A device designed as a coupling device can, for example, be used in a steering specification device for specifying a steering movement according to the steer-by-wire concept. Then, in particular, one of the rotating components can be coupled to a drive and one of the rotating components can be coupled to an output.

In an advantageous application of the device according to the invention, the transmission device can be provided as a braking device for a hinge. The braking resistance of the rotary movement of the hinge (or of components fixed to the respective rotary component of the transmission device) is preferably specifically adjustable. In this context, the fault case can alternatively be referred to as a parking brake case, in which the fault brake device (=parking brake device) provides a (high, in particular maximum) braking torque (parking brake torque) when the coil is not energized. The normal case can in this context be referred to as a position change case, in which the hinge can be operated easily. Preferably, the parking brake device is provided by the aforementioned permanent magnet device and/or the aforementioned remanence device, so that in the parking brake case no current is applied and yet a movement of components connected to the hinge is braked against each other with the parking brake torque. By weakening the permanent magnet or the remanence device using the coil device, the hinge can preferably be set to a reduced braking torque for (slight) movement of the components relative to one another. This means that the hinge can be operated with very little effort (=position change case). In the desired relative position of the hinge, the current supply to the coil device is preferably stopped again, thus in particular causing a fixation in a new locking position (which saves energy or does not require energy). The locking positions can preferably be set over the entire actuation range of the hinge in any desired or intended position. The applicant reserves the right to claim a device which is suitable and designed for such an application.

The applicant reserves the right to claim the following subject matter: Device comprising at least one magnetorheological transmission device with at least two rotary components that can be moved relative to one another, at least one effective gap being formed between the rotary components and a magnetorheological medium being arranged in the effective gap, and comprising at least one electrical coil device for generating a controllable magnetic field in the effective gap in order to influence the rotatability of the rotating components in normal operation (or in the event of a position change), and comprising at least one parking brake device for braking the rotatability of the rotating components in the event of a loss (Non-presence of the magnetic field of the electrical coil device (or independent of the magnetic field of the electrical coil device or when the coil device is inactive); wherein the parking brake device is suitable and designed to generate a magnetic field by means of at least one magnetic field generating device and to use the magnetic field to influence the magnetorheological medium arranged in the effective gap in order to brake the rotatability of the rotating components with a parking brake torque; and comprising a hinge device with two hinge units that can be pivoted relative to one another (over a pivot angle range), at least one of the hinge units is coupled to one of the rotating components, so that the pivoting of the hinge units by means of the transmission device in normal operation or in a position change case (in which a relative position of the hinge units to one another is changed) can be braked in a targeted (adjustable) manner and so that the pivotability of the hinge units by means of the parking brake device in a parking brake case (in which the magnetic field of the electrical coil device is not present or the Coil device is inactive) can be braked in a targeted manner.

The magnetic field generating device of the parking brake device is designed in particular as described here for the magnetic field generating device of the accident prevention system. In particular, the magnetic field generating device comprises at least one permanent magnet device and/or at 7 least one remanence device or is designed as such. The parking brake device is preferably (and to the extent that it makes sense and is feasible) designed like the emergency safety device. In particular, the electrical coil device is suitable and designed to specifically counteract the magnetic field of the magnetic field generating device, so that the parking brake torque is at least partially eliminated if necessary (in particular at least in normal operation or in the event of a position change) and the relative position of the hinge units to one another can be changed without the parking brake torque. In particular, the parking brake device is suitable and designed to determine the pivotability of the hinge units at any angular position of an intended pivot angle range of the hinge units.

The rotary components are in particular arranged coaxially to one another and/or coaxially to the axis of rotation of the transmission device. In particular, one rotation component can be called the inner rotation component and another rotation component can be called the outer rotation component be referred to. In particular, the inner rotation component and/or the outer rotation component can be equipped with the magnetic field generating device.

In particular, the coil holder is arranged on (only) one of the rotating components. The permanent magnet device can be arranged on one or both rotating components. The permanent magnet device can be arranged on the same rotating component as the coil holder. Additionally or alternatively, the permanent magnet unit can be arranged on the rotating component, which is designed without the coil holder.

In the intended operating state, one of the rotating components in particular is designed to be stationary and, in particular, is accommodated on a torque support. In particular, the torque support is an abutment structure (can also be referred to as a support structure) and e.g., is part of a body or a console or the like. In particular, the coil device and/or the additional coil device is arranged on the fixed rotating component. In particular, the supply lines run through the fixed rotary component. The fixed rotation component can be the inner or the outer rotation component.

In all embodiments, it is preferred that the magnetorheological medium comprises magnetorheological particles and gas as a filling medium. In particular, the magnetorheological particles are absorbed in air. In particular, the magnetorheological medium is designed as a powder. With such a magnetorheological medium, the invention presented here enables a particularly low basic torque. Alternatively, it is conceivable and possible for the magnetorheological medium to contain magnetorheological particles and a carrier liquid, such as e.g., oil, water or alcohol.

It is particularly preferred that the magnetorheological particles (each) consist predominantly of carbonyl iron powder or derivatives thereof. Other magnetorheologically responsive particles are also possible. The magnetorheological particles can have coatings to protect against abrasion and/or corrosion and/or additional components to make the magnetorheological particles more stable, more abrasion-resistant and/or more slippery during operation. The magnetorheological medium and/or the magnetorheological particles can, for example, comprise a graphite additive.

In the context of the present invention, a magnetically non-conductive material is understood to mean, in particular, a material with a permeability number of less than ten and preferably less than one. Materials with a permeability number greater than ten and preferably ferromagnetic materials are understood to be magnetically conductive here. The magnetic conductivity is the “relative magnetic permeability”, which is also simply called “magnetic permeability”.

Further advantages and features of the present invention result from the exemplary embodiments, which are explained below with reference to the accompanying figures.

Show in it:

FIG. 1 is a purely schematic representation of a device according to the invention in a perspective view;

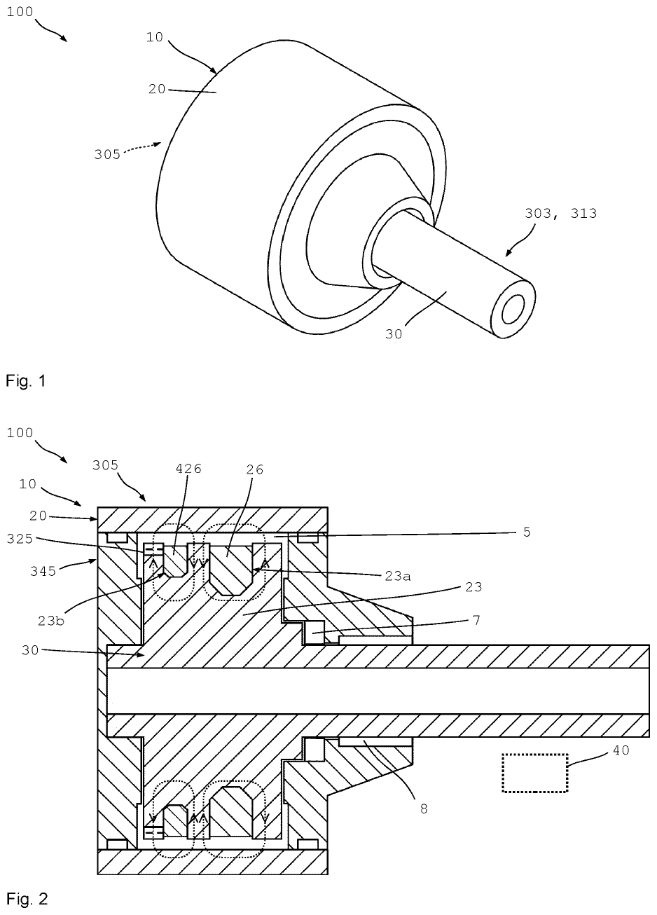

FIG. 2 shows the device of FIG. 1 in a section side view;

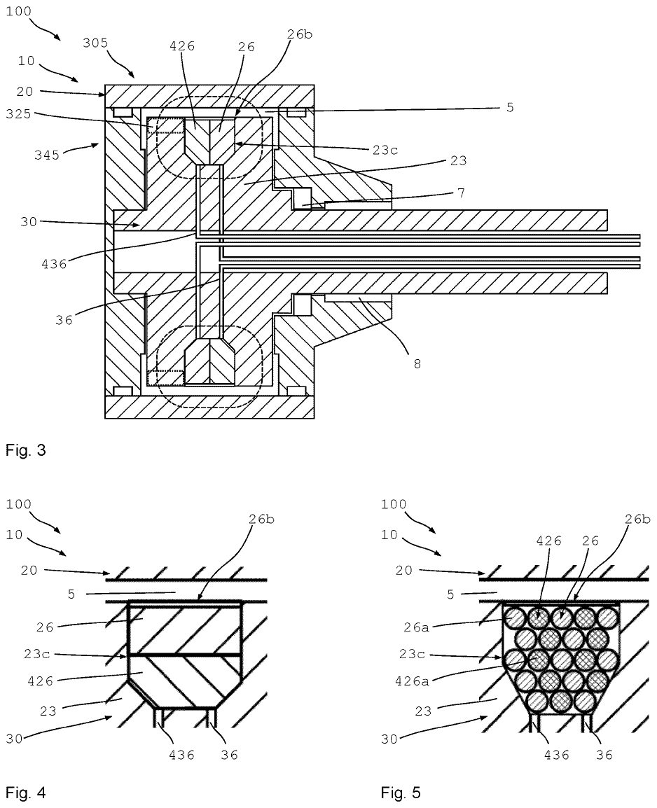

FIG. 3 shows another device in a section side view;

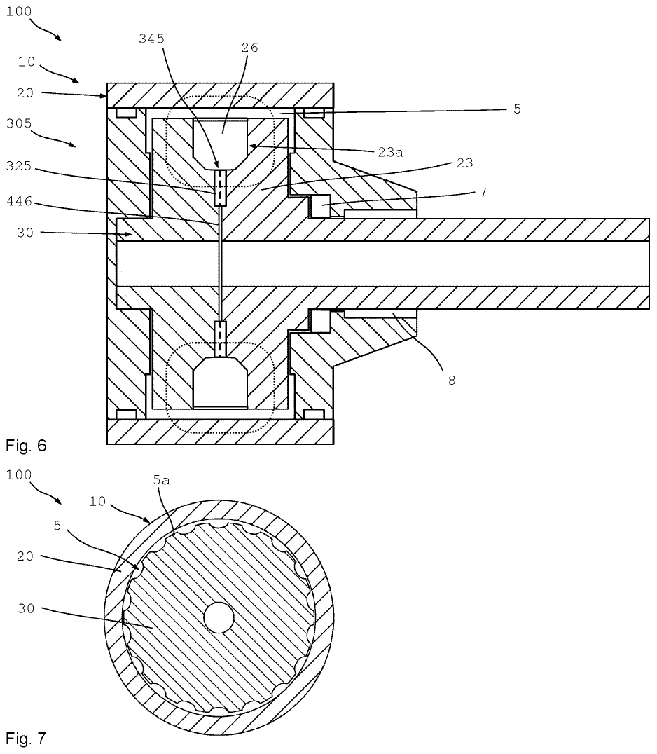

FIGS. 4-5 show detailed representations of embodiments of the coupling device according to FIG. 3;

FIG. 6 shows another device in a section side view;

FIG. 7 shows the device in section front view; and

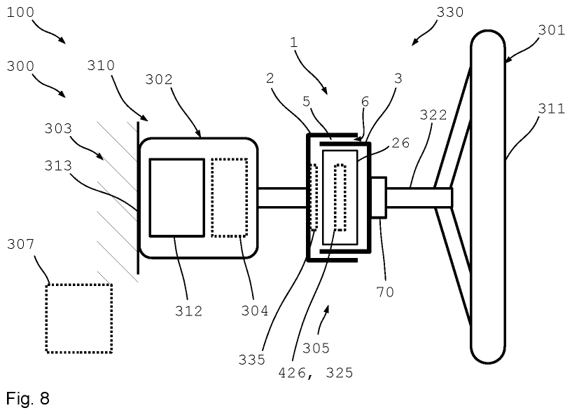

FIG. 8 is a purely schematic representation of the principle of a device designed as a steering control device.

FIG. 1 shows a device 100 according to the invention with a magnetorheological transmission device 10 with two rotating components 20, 30 and an accident protection 305, not visible here, with a magnetic field generating device 345 for braking the rotatability of the rotating components 20, in the event of an accident. For reasons of visibility, the dimensions or ratios are shown here and in the other figures purely schematically and, in particular, not to scale.

The device 100 here is, for example, an operating device. For this purpose, the (outer) rotary component 20 is designed, for example, as a rotary knob or as a thumb roller. The transmission device 10 then generates haptic feedback while the rotary knob or the thumb roller is rotated to set operating states.

The device 100 can, for example, also be designed as a steering specification device 300, as described in more detail with reference to FIG. 8. The transmission device 10 then serves, for example, as an actuator in a steer-by-wire steering unit of a vehicle or in a steering wheel of a game controller.

The (inner) rotating component 30 is mounted in a rotationally fixed manner on a torque support 303 (not shown here) and, for example, on an abutment structure 313 (console, body, etc.). The outer rotating component 20 is rotatably mounted on the inner rotating component 30. For this purpose, a bearing unit 8 and, for example, a plain bearing are provided here (see FIG. 2).

FIG. 2 shows the internal structure of the device 100 of FIG. 1. An effective gap 5 is formed between the rotating components 20, 30, in which a magnetorheological medium 6 is arranged. The dimensioning of the effective gap 5 is not drawn to scale here and in the other figures for reasons of visibility. A seal 7 is provided to seal the effective gap 5. A magnetic field is generated via a coil device 26 attached to the inner rotating component 30. The magnetic field influences the medium 6 so that the mobility of the rotating component 20 is subjected to a targeted torque.

The rotating component 30 is equipped with a coil holder 23, which here has two receiving spaces 23a, 23b. The coil device 26 for operating the coupling device 1 is arranged in the receiving space 23a. The (additional) coil device 426 of the accident protection device 305 is located in the receiving space 23b. The magnetic circuits are shown here with dashed lines.

The magnetic field for the emergency braking torque is generated by a permanent magnet device 325. To cancel the fault braking torque in normal operation, the magnetic field of the permanent magnet device 325 is specifically superimposed with a magnetic field of the coil device 426.

Alternatively, the malfunction protection 305 shown here can also be equipped without the permanent magnet device 325. Then the emergency braking torque is generated with the coil device 426. For this purpose, the coil device 426 is, for example, equipped with its own separate energy supply (own energy storage and/or separate supply line). FIG. 3 shows a device 100 in which the coil devices 26, 426 are accommodated in a common receiving space 23c. The coil device 426 can be used to generate the magnetic field in the event of an accident. The common magnetic circuit is shown here with dashed lines.

However, it is also possible for the magnetic field to be provided in the event of a fault by means of a permanent magnet device 325, shown here in dashed lines. Then, in normal operation, the coil device 426 serves to cancel or weaken the magnetic field of the permanent magnet device 325. The coil devices 26, 426 are each equipped with their own supply line 36, 436.

A winding arrangement 26b is provided here for the coil devices 26, 426, in which they are arranged axially next to one another in the receiving space 23c. The coil devices 26, 426 can be arranged structurally separated from one another in the receiving space 23c by means of a magnetically non-conductive, in particular annular, separating layer (not shown here).

FIG. 4 shows an alternative winding arrangement 26b of the coil devices 26, 426. A coaxial winding arrangement 26b is provided here, in which the coil device 26 is located radially outside and the coil device 426 is located radially inside. If required, a reverse arrangement can also be provided. Here too, a separating layer (here, for example, in the shape of a cylinder jacket) can be provided between the coil devices 26, 426.

In FIG. 5, the coil devices 26, 426 are wound together and accommodated in the common receiving space 23c. The coil devices 26, 426 each have at least one electrically insulated conductor 26a, 426a. When producing the winding arrangement 26b, both conductors 26a, 426a were simultaneously wrapped in the receiving space 23c, resulting in the multiple winding shown here. The conductors 26a, 426a or wires of the coil devices 26, 426 are greatly enlarged here for better visibility and are not shown true to scale.

FIG. 6 shows a device 100 in which the fault protection device 305 has a permanent magnet device 325 which is arranged radially within the coil device 26. In addition to its actual function, the coil device 26 also serves to weaken or cancel the magnetic field of the permanent magnet device 325 in normal operation. The permanent magnet device 325 is designed here as a ring magnet, which extends radially inwards only over a part of the rotating component 30. In order to prevent a magnetic short circuit, a magnetic flux barrier 446 and, for example, an air gap is formed here radially within the permanent magnet device 325.

The magnetically conductive sections of the rotary components 20, 30 projecting into the gap 5 (e.g. axially next to the receiving space 23c) can be equipped with a circumferential contour. This results in a different gap height in the circumferential direction. For example, a star contour 5a or the like can be provided, as shown in FIG. 7.

As outlined in FIG. 2, an internal or external control device 40 can be provided in order to use the magnetic field of the permanent magnet device 325 and/or the additional coil device 426 in normal operation to support the magnetic field of the coil device 26.

FIG. 8 shows a device 100, which acts as a steering control device 300 for controlling a vehicle 330, only partially shown here, according to the steer-by-wire concept. For this purpose, a steering unit 301, designed here as a steering wheel 311, is electrically or electronically connected to an actuator device 307. The actuator device 307 can, for example, adjust one or two or more wheels of the vehicle 330 and thereby adjust the steering movement carried out with the steering unit 301 implement a vehicle movement.

The movement or position of the steering unit 301 and/or the torque is detected here with a sensor device 70 and, for example, with a rotation angle sensor or torque sensor or a combination of both.

The steering unit 301 is here integrated into a power train 310, which also includes a drive device 302 with an electric drive motor 312 and a magnetorheological clutch device 1 with clutch components 2, 3. The clutch device 1 and its clutch components 2, 3 are provided by the transmission device 10 with its rotating components 20, 30. The transmission device 10 here is, for example, designed as described above.

The clutch device 1 is connected in series (in series) to the drive device 302 in the power train 310 in order to be able to specifically change the power flow between the drive device 302 and the steering unit 301.

In the example shown here, the clutch device 1 is arranged between the steering unit 301 and the drive device 302 in the power train 110. The steering unit 301 is connected to the coupling component 3 in a rotationally fixed manner via a steering shaft 322. The coupling component 2 is connected to the drive device 302 in a rotationally fixed manner. For example, the clutch component 2 can be actively rotated by the drive motor 312.

The drive device 302 is here attached to an abutment structure 313 of the vehicle 330, which serves as a torque support 303 for the drive device 302. Depending on how the adhesion between the clutch components 2, 3 is set, the torque coming from the drive device 302 is transmitted to the steering unit 101 in full or to a certain extent or not at all.

In order to provide a particularly strong and even more reliable torque support 303 for the clutch device 1, the steering specification device 300 shown here can be equipped with a self-locking gear device 304 (e.g., worm gear) in a further development. The transmission device 304 is, for example, part of the drive device 302 and is connected between the drive motor 312 and the clutch device 1.

The failure protection device 305 serves to ensure that the steering unit 301 is not blocked in the event of a failure and cannot be moved without resistance. It is equipped, for example, with the additional coil device 426 and the permanent magnet device 325 and its own electrical energy storage device 335.

The coil receptacle 23 presented here or the special winding arrangement 26b provides a particularly safe and reliable malfunction protection 305. At the same time, only a small amount of installation space is required, so that accommodation within the (inner) rotating component 30 is possible. By integrating it into a common magnetic circuit, the additional coil device 426 can also be used to remedy excessive current supply to the coil device 26 in the event of a fault. This means that their magnetic field can be completely canceled if necessary.

List of Reference Symbols:

| | |
|---|---|
| 1 | Magnetorheological |
| | Clutch Device |
| 2, 3 | Coupling Component |
| 4 | Component |
| 5 | Gap |
| 6 | Medium |
| 7 | Seal |
| 8 | Bearing Unit |
| 10 | Transmission Device |
| 20 | Rotating Component |
| 23 | Coil Holder |
| 23a | Receiving Space |
| 23b | Receiving Space |
| 23c | Receiving Space |
| 26 | Coil Device |
| 26a | Conductor |
| 26b | Winding Arrangement |
| 30 | Rotating Component |
| 36 | Supply Line |
| 40 | Control Device |
| 70 | Sensor |
| 100 | Device |
| 300 | Steering Input Device |
| 301 | Steering Unit |
| 302 | Drive Device |
| 303 | Torque Support |
| 304 | Transmission Device |
| 305 | Fault Protection |
| | Device |
| 307 | Actuator Device |
| 310 | Powertrain |
| 311 | Steering Wheel |
| 312 | Drive Motor |
| 313 | Support Structure |
| 322 | Steering Shaft |
| 325 | Permanent Magnet |
| | Device |
| 330 | Vehicle |
| 335 | Energy Storage Device |
| 345 | Magnetic Field |
| | Generation Device |
| 426 | Additional Coil |
| | Device |
| 426a | Conductor |
| 436 | Supply Line |
| 446 | Flux Barrie |

1-19. (canceled)

20. A device comprising:
at least one magnetorheological transmission device having at least two rotating components that can be moved relative to one another;
at least one gap being formed between the rotating components;
a magnetorheological medium being arranged in the gap;
at least one electrical coil device configured to generate a controllable magnetic field in the gap to influence the rotatability of the rotating components in a normal operation;
at least one malfunction protection device configured to brake the rotatability of the rotating components in the event of a malfunction; and
the malfunction protection device being configured to generate a magnetic field via at least one magnetic field generating device and to influence the magnetorheological medium arranged in the gap with the magnetic field to brake the rotatability of the rotating components with an emergency braking torque.

21. The device according to claim 20, wherein the magnetic field of the coil device and the magnetic field of the magnetic field generating device act on the same gap.

22. The device according to claim 20, wherein the magnetic field of the coil device and the magnetic field of the magnetic field generating device run through the rotating components and the gap.

23. The device according to claim 20, wherein the magnetic field of the coil device and the magnetic field of the magnetic field generating device run at least partially through a common magnetic circuit.

24. The device according to claim 20, wherein the magnetic field generating device comprises at least one additional electrical coil device for generating the magnetic field.

25. The device according to claim 24, wherein the additional coil device is configured to be smaller and/or have a lower power than the coil device.

26. The device according to claim 24, wherein the additional coil device and the coil device each have at least one separate supply line for supplying energy.

27. The device according to claim 26, wherein the malfunction protection device has at least one energy storage for supplying energy to the additional coil device and the energy storage provides an energy supply which is independent of an energy supply to the coil device

28. The device according to claim 24, wherein at least one of the at least two rotating components has at least one coil receptacle accommodating the coil device and the additional coil device.

29. The device according to claim 28, wherein the coil receptacle has a common receiving space for the coil device and the additional coil device, or the coil receptacle has at least one receiving space for the coil device and at least one receiving space for the additional coil device.

30. The device according to claim 28, wherein the coil device and the additional coil device are accommodated in a common winding arrangement and the coil device and the additional coil device are wound axially next to one another or wound coaxially to one another or wound into one another in the winding arrangement.

31. The device according to claim 24, wherein the magnetic field generating device has at least one permanent magnet device for providing the magnetic field and wherein the malfunction protection device is configured to weaken or eliminate the magnetic field of the permanent magnet device in normal operation by means of the coil device and/or the additional coil device.

32. The device according to claim 31, wherein the permanent magnet device is annular.

33. The device according to claim 31, wherein the permanent magnet device is arranged axially next to the coil device and/or the additional coil device.

34. The device according to claim 31, wherein the permanent magnet device is enclosed in a radial direction by the coil device and/or the additional coil device; or the permanent magnet device surrounds the coil device in the radial direction and/or the additional coil device.

35. The device according to claim 31, wherein the permanent magnet device is assigned at least one magnetic flux barrier, the magnetic flux barrier being configured to prevent a magnetic short circuit between the permanent magnet device and the rotating component carrying the permanent magnet device, and the permanent magnet device and the flux barrier are arranged coaxially to one another.

36. The device according to claim 35, wherein the flux barrier is an air gap or at least has an air gap.

37. The device according to claim 24, wherein the malfunction protection device is configured to reduce the magnetic field of the coil device via the additional coil device to counteract an undesirably large braking effect in the event of a malfunction.

38. The device according to claim 20, further comprising at least one control device configured to control the magnetic field of the magnetic field generating device in normal operation to support the magnetic field of the coil device.
